(19) United States
(12) Patent Application Publication
(10) Pub. No.: US 2026/0353093 A1
(43) Pub. Date: Nov. 5, 2026

(54) LOCATION-BASED USER EQUIPMENT RADIO ACCESS MANAGEMENT BY A MOBILE NETWORK OPERATOR CORE

(71) Applicant: T-Mobile Innovations LLC, Overland Park, KS (US)

(72) Inventors: Bashir A. HASWAREY, Elmhurst, IL (US); Mohammad ABU-SAMRA, Orland Park, IL (US); Narothum SAXENA, Hoffman Estates, IL (US); Michael S. IRIZARRY, Barrington Hills, IL (US)

(21) Appl. No.: 19/194,514

(22) Filed: Apr. 30, 2025

(51) Int. Cl. H04W 12/63; H04W 60/04; H04W 76/10

(52) U.S. Cl. CPC H04W 12/63; H04W 60/04; H04W 76/10

(57) ABSTRACT

A system and method, carried out by a mobile network (MN) core, are described for conditionally allowing a requested radio connection of an identified user equipment (UE) device associated with a mobile network operator associated with the MN core. The conditional access is based upon provided user equipment geographic location information indicating a current geographic location of the UE device seeking to establish the requested radio connection. The method includes receiving, by an MN core component, an access request including the user equipment geographic location information indicating a current geographic location of the identified UE device. The MN core component, in accordance with receiving the access request, determines that the current geographic location of the identified UE device is within a pre-configured limited geographic area description within which the identified UE device is permitted radio access to the MN operator.

### FIELD OF THE INVENTION

The present disclosure generally relates to mobile wireless communications. More particularly, the present disclosure is directed to managing limited access by user equipment to radio access network nodes in a particular geographic area via an access policy implementation extension to a mobile network operator core component such as a GTP Proxy.

### BACKGROUND OF THE INVENTION

A variety of private entities utilize significant quantities of sensors and other data acquisition devices that are connected via mobile wireless networks to various centralized data acquisition and storage servers that maintain and thereafter process the acquired data.

Private enterprises (e.g., power utilities), under a mobile virtual network operator (MVNO) model, strive to limit their application-specific user equipment (UE) to operate within at a specific geographic area. Such UE devices are Internet-of-things communications-enabled sensors configured to operate on an essentially permanent basis at specific geographic locations by communicatively connecting to the private enterprise MVNO core through particular radio access network (RAN) resources (e.g., cell tower, femtocell, etc. in the vicinity of the installed sensors/UE devices) of a mobile network operator (MNO). As such, it is desirable for installed sensors/UE devices to only connect to specific/intended RAN nodes within the geographic area. As such, it would be desirable for the MNO to provide an ability to provide a capability to configure and thereafter control access by specific sensors/UE devices installed at particular geographic locations to particular pre-configured (whitelisted) RAN resources, provided by the MNO, as a service to private enterprises. Such capability enhances security by ensuring the RAN link is established with a trusted and reliable MNO operator and moreover ensures that the specific sensors/UE devices are incapable of being used if removed from their pre-configured geographic operating location.

### SUMMARY OF THE INVENTION

A method, carried out by a mobile network (MN) core, is described for conditionally allowing a requested radio connection of an identified user equipment (UE) device associated with a mobile network operator associated with the MN core, wherein conditional access is based upon provided user equipment geographic location information indicating a current geographic location of the UE device seeking to establish the requested radio connection. The method includes receiving, by an MN core component, an access request including the user equipment geographic location information indicating a current geographic location of the identified UE device. The method further includes determining, by the MN core component in accordance with receiving the access request, that the current geographic location of the identified UE device is within a pre-configured limited geographic area description within which the identified UE device is permitted radio access to the MN operator. Thereafter, the method includes generating, in accordance with the determining, an access granted message indicating permission for the UE device to connect to the MN operator through a radio access network (RAN).

Furthermore, a system is described that comprises a mobile network (MN) core including at least one processor carrying out the functionality of a GPRS Tunneling Protocol (GTP) proxy and a non-transitory computer-readable medium including computer-executable instructions that, when executed by the at least one processor, facilitate carrying out a method for conditionally allowing a requested radio connection of an identified user equipment (UE) device associated with a mobile network operator associated with the MN core, wherein conditional access is based upon provided user equipment geographic location information indicating a current geographic location of the UE device seeking to establish the requested radio connection. The method includes receiving, by an MN core component, an access request including the user equipment geographic location information indicating a current geographic location of the identified UE device. The method further includes determining, by the MN core component in accordance with receiving the access request, that the current geographic location of the identified UE device is within a pre-configured limited geographic area description within which the identified UE device is permitted radio access to the MN operator. Thereafter, the method includes generating, in accordance with the determining, an access granted message indicating permission for the UE device to connect to the MN operator through a radio access network (RAN).

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1A is a schematic diagram of an exemplary mobile wireless network radio network environment including a primary MNO and two private mobile wireless networks including a private RAN and core network belonging to distinct enterprises through which respective private network devices of the primary MNO establish an air connection in accordance with the disclosure;

FIG. 1B summarizes fields of an exemplary entry in a structure (e.g. table, spreadsheet, etc.) maintained by an access policy module (APM) extension to a GTP proxy of a primary MNO to provide access to a set of whitelisted RAN resources to which particular UE devices are permitted to establish a radio link in accordance with the disclosure;

FIG. 2 is a sequence diagram summarizing messaging flow for executing connection signaling messaging in a case where a UE device seeks to establish a radio connection to an MVNO core via a particular identified RAN resource in accordance with an illustrative example of the disclosure;

FIG. 3 is a flowchart summarizing operation of access policy module to enforce a geographic limitation on where a user equipment device may connect to an MVNO core via a RAN resource; and

FIG. 4 is a sequence diagram summarizing messaging flow for executing connection signaling messaging in a case where a UE device seeks to update a radio connection to a private enterprise MVNO core via a particular identified RAN resource in accordance with an illustrative example of the disclosure.

### DETAILED DESCRIPTION OF THE DRAWINGS

A system, in accordance with the present disclosure, includes a primary MNO hosting (for administrative purposes) private user equipment (UE) devices associated with private mobile wireless networks including an MVNO core to which the private UE devices seek to communicatively connect. Such support may also be carried out via a secondary MNO providing roaming access for the private UE devices on behalf of the primary MNO. The primary MNO core, includes, in accordance with the present disclosure, an access policy module (APM) extension to a GTP proxy of the MNO that maintains, for each identified UE device of a set of UE devices of a private enterprise, a pre-configured whitelist of specific RAN node resource instances to which particular ones of the identified UE devices are permitted to establish a radio connection for establishing a communicative connection to an MVNO core with which the particular identified UE devices are associated.

By way of an illustrative scenario incorporating the APM extension to the GTP proxy, a private enterprise utilizes an MVNO including UE devices/sensors that require both on-net and off-net service where communications between the UE devices/sensors and the MVNO (whether through a RAN interface provided by the primary MNO or a secondary MNO (roaming partner) exhibit the following features: (a) support secure communications with the MVNO core of private enterprise customers (e.g. utilities); (b) restrict cellular (data/sms/voice) service to designated sites; and (c) automatically configure and thereafter lock down of specific UE access to specific RAN interface resources at a geographic location at which specific UE devices are installed.

In the above-summarized scenario, the GTP Proxy utilizes the APM extension to enforce specific UE device access to particular RAN interface resources based on a pre-configured listing of particular identified RAN resources associated with a particular identifier associated with the specific UE device.

By way of example, the APM extension is configured by use of a user interface that provides a variety of information supporting the configuration of specific whitelists of RAN resources for identified UE devices/sensors of a private enterprise having an MVNO to which the identified UE devices/sensors communicatively connect via an MNO core of the primary MNO including the APM extension-enhanced GTP proxy. The configuration user interface supports defining a RAN resource access policy (geolocation select/associate areas of operation to groups of UEs identified via IMSI block). Thereafter, a defined geolocation may be translated into a list of Tracking Area Codes (TACs)—where each TAC includes a Tracking Area Identifier (TAI) and Cell ID combination.

Thereafter, the TACs are used by the APM extension of the GTP Proxy to enforce access control based on the UE's location during a UE attach and/or UE mobility scenario.

By way of example, the APM extension enforces a preconfigured policy for specific UE devices based on: an International Mobile Subscriber Identity (IMSI) description that is specified: individually, by a block (IMSI value range), and/or by a group of individually listed identifiers); and an associated listing of permitted RAN interface resources (e.g. TAC/Cell level listing)-including specifying a geographic area (as opposed to specific identifiers of RAN nodes/cells) since the RAN node/cell physical hardware may change without notice to the private enterprise with which the UE devices are associated.

The configuration of UE device access to RAN resources supports non-continuous/disjoint coverage areas across the globe. Moreover, the configuration user interface supports designating: service type restrictions such as: type of service, for example, broadband restricted sites locations, RAT type (LTE, New Radio, Narrowband), etc.; and location(s) of supported RAN interface services (white-list). The user interface supports a geographic map view for specifying a UE device location. Additionally, a listing of RAN resources may be established by installing the UE device and sensing RAN resources within the installation area to establish an initial whitelisted set of locations from which a allowable RAN resources may be subsequently determined.

The APM extension operation is divided into “learning” (configuration) and “enforcement” phases. During the learning phase, in a auto-configuration arrangement, a particular UE device starts with an unrestricted (all locations) geographic definition. The particular UE device is thereafter installed/deployed at a particular geographic location where, during a configuration period a listing of TAIs and Cell Global Identifiers (CGIs) are obtained. Upon completion of the configuration period, the listing of TAIs and CGIs are reviewed and edited (removing any non-permitted RAN interface resources) to render a final listing that is used by the APM extension during the enforcement phase to restrict access by identified UE devices to particular RAN interface resources contained in the previously-configured list of RAN interface resources established during the “learning” phase.

The above-summarized operation of a GTP proxy enhanced with an APM extension in accordance with the present disclosure is further described, by way of detailed examples, herein below.

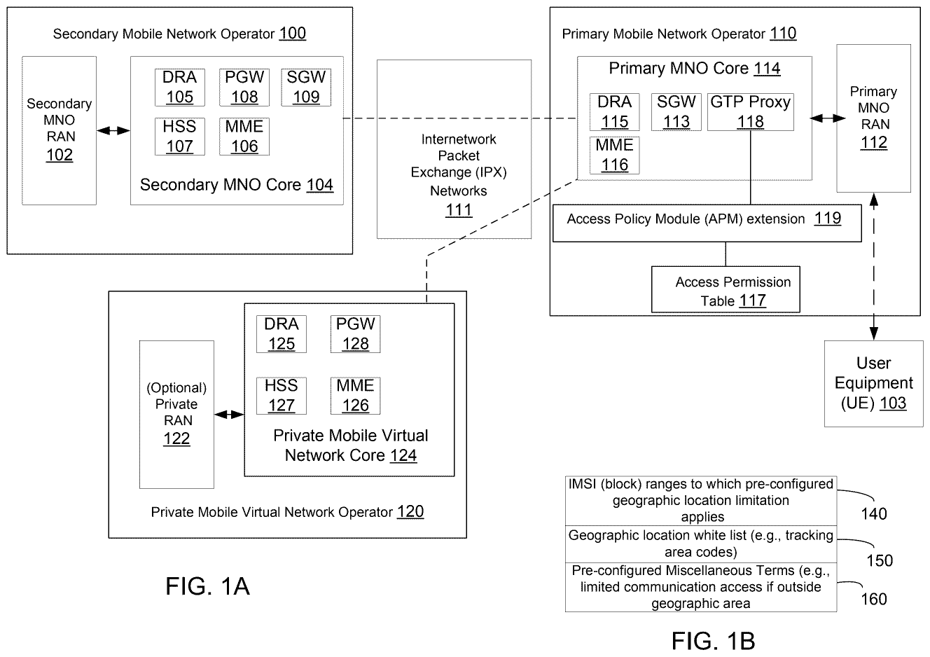

Turning to FIG. 1A, an exemplary environment for carrying out the present disclosure is schematically depicted. A secondary mobile wireless network operator (MNO) 100, operating as a roaming mobile wireless data services host, includes a secondary MNO RAN 102 and a secondary MNO core 104 network. The secondary MNO RAN 102 is configured to receive a Diameter Protocol connection signaling message from a UE device 103 affiliated with a private mobile virtual network operator (MVNO) 120. The secondary MNO 104 includes: a Diameter routing agent (DRA) 105, a mobility management entity (MME) 106, a home subscriber server (HSS) 107, and a packet gateway (PGW) 108.

The secondary MNO 100 is configured to communicate through a primary mobile network operator (MNO) 110 (or more generally a network operator (NO) network that may/may not operate an associated RAN) via an internetwork data packet exchange (IPX) of a plurality of IPX networks 111. By way of example, communications associated with UE devices seeking/having connectivity to the private MVNO 120 via the secondary MNO 100 and the primary MNO 110 are carried out according to any established communications protocols, including a protocol under which affiliation with a particular MN operator/service provider entity is determined in accordance with IMSI blocks (ranges of IMSI values) assigned by the primary MNO 110 or provided by (i.e., bring your own IMSI) the private MVNO 120.

The primary MNO 110 includes a primary MNO core 114 that includes: a session gateway (SGW) 113, a DRA 115, an MME 116, and a GPRS Tunneling Protocol (GTP) proxy 118. In accordance with the present disclosure, the primary MNO 110 also includes an access policy module (APM) extension 119 that, in accordance with an illustrative example, operates as an extension of the GTP proxy 118 to apply a limited access definition for the UE device 103 that restricts connection to RAN interface resources identified in a pre-configured whitelist maintained by the APM extension 119 for specifying particular RAN interface resources to which the UE device is permitted to establish a connection.

With continued reference to FIG. 1A, the private MVNO 120 includes a (optional) private RAN 122 and a private MVNO core 124 network. The private MVNO core 124 includes: a Diameter routing agent (DRA) 125, a mobility management entity (MME) 126, a home subscriber server (HSS) 127, and a packet gateway (PGW) 128.

The private MVNO 120 is configured to communicate with associated UE devices through the primary MNO 110 via an internetwork data packet exchange (IPX) of the plurality of IPX networks 111. By way of example, communications associated with the UE device 103 seeking/having connectivity to the private MVNO 120 via the primary MNO 110 are carried out according to any established communications protocols, including a protocol under which affiliation with a particular MN operator/service provider entity is determined in accordance with IMSI blocks (ranges of IMSI values) assigned by the primary MNO 110 or provided by (i.e., bring your own IMSI) the Enterprise B MN 120.

The APM extension 119 of the GTP proxy 118, in accordance with the present disclosure, operates as a manager of location-limited RAN interface resource access for UE devices (e.g. UE device 103) associated with the private MVNO 120. In particular, the APM extension 119 executes location-geographic area based limited RAN resource access by applying an IMSI of the UE device associated with an access request to an access permission table 117 (see FIG. 1B). The access permission table 117, utilized by the APM extension 119, specifies on an identified UE device (e.g. IMSI) basis, access to a set of whitelisted geographic locations at which the particular identified UE device is permitted to establish a radio link connection for communicating under the authority of the private MVNO 120. Allowed geographic locations are described, for example, by a combination of Tracking Area Identifier (TAI) and an e-Cell Global Identifier (ECGI)).

With continued reference to FIG. 1B, in accordance with an illustrative example, an access permission table 117 includes a data structure element, for an identified UE device (or a plurality of UE devices configured as a group), specifying a pre-configured (“whitelisted”) set of geographic locations at which the identified UE device is allowed to connect to an available RAN interface resource. By way of example, an access record entry, schematically depicted in FIG. 1B, includes the following information: a UE device identifier (or UE device group identifier) 140, a geographic location set 150, and supplemental terms of access (service level, priority, minimized access etc.) 160. By way of example, the UE device identifier 140 is provided as one or more IMSI values corresponding to a single, group, or range/blocks of IMSI values.

The geographic location set 150 is provided, for example, as a set of TAC (tracking area code) values, where each TAC is a combination of a Tracking Area Identifier (TAI) and a Cell Identifier—e.g., an ECGI). The content of individual access record entries of the access permission table may include additional or differing information in accordance with various implementations of the present disclosure.

In accordance with the present disclosure a combination of UE device identifier 140 and geographic location set 150 information is used by the APM extension 119 of the GTP proxy 118 to enforce a geographic access limitation on a requesting UE device located at a particular location at the time seeking to establish a wireless communication connection.

Thus, in summary of the above, the APM extension 119 enforces a pre-configured geographic location access limit upon UE requests to connect to a RAN interface resource by applying provided identification information for a particular UE device seeking to connect to a RAN interface resource to a set of pre-configured access definitions (see FIG. 1B).

Such access can be further limited (e.g., to a particular level of service, time of day, etc.) in accordance with further stored access configuration definitions maintained in the supplemental terms of access 160.

With continued reference to FIG. 1A, it is noted that simplified depictions are provided of the primary MNO 110, the secondary MNO 100, and the private MVNO 120 to emphasize enhanced aspects of the primary MNO 110 relating to the APM extension 119 to the GTP proxy 118 that operates as a manager of geographic location-based limited access provided to particular identified UE devices. Notably, while a single UE device 103 is depicted in FIG. 1A, hundreds or even thousands of such devices are present in private MVNO implementations.

Having described an illustrative example where the APM extension 119 functionality is carried out in the primary MNO 110 as an extension of the GTP Proxy 118, the functionality of the APM extension 119 is alternatively carried out in a “distributed” arrangement. By way of example, functionality of the APM extension 119 is implemented as an extension of a core network component of either or both the secondary MNO 100 and/or the private MVNO 120. In such case, the APM extension 119 of the GTP proxy 118 may operate as a centralized manager with respect to replicating and pushing updates to the contents of the access permission table 117 to participating MNOs (executing localized versions of the APM extension 119 functionality) for propagating updated versions of the contents of the access permission table 117 to the participating MNOs.

While the contents of an individual record/entry of the access permission table 117 can be established in virtually any manner, one such particular way is to allow a UE device instance to operate at a particular site (i.e. geographic location) for a ‘learning period’ wherein the UE device obtains, in known manner, an initial list of all RAN nodes that are within radio range of the UE device operating at a specified geographic location (e.g., associated with a particular location associated with an identified TAC). The resulting list is thereafter used to build a set of white listed RAN nodes in a particular geographic location (identified by particular TAC values).

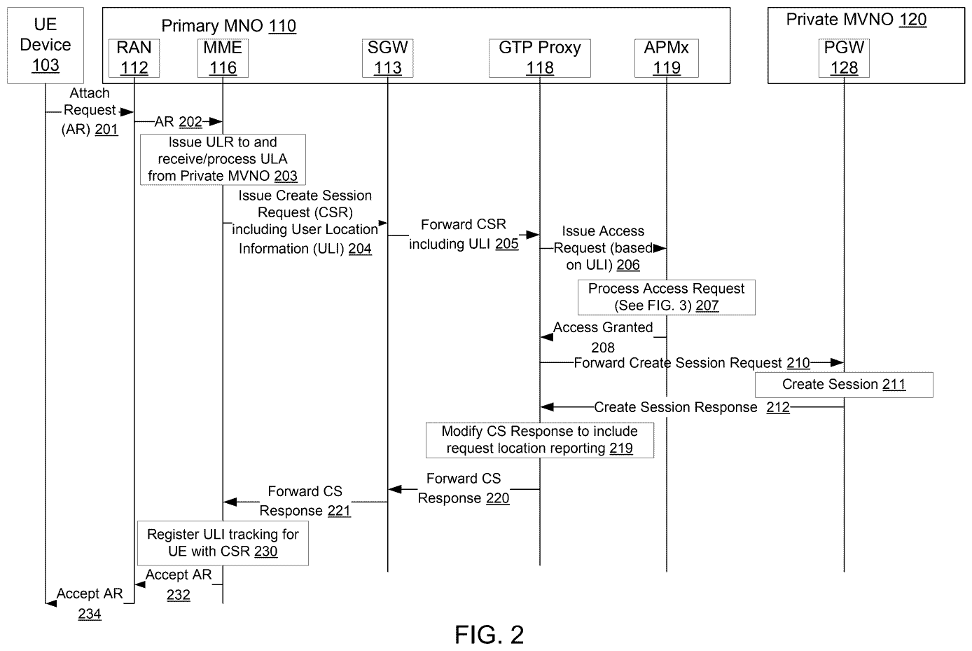

Turning to FIG. 2, a sequence diagram summarizes a message flow for handling an on-network request (i.e., one received initially by the primary MNO 110-as opposed to the secondary MNO 100 in a roaming arrangement) originating from the UE device 103 (having an IMSI in a range of IMSIs assigned to the private MVNO 120), to establish a connection to the primary MNO 110 (having a RAN node proximate a geographic region to which the UE device 103 is restricted).

With continued reference to FIG. 2, during 201 the UE device 103 issues an Attach Request (AR) message including one or more pieces of known user location information (ULI) that is received by the RAN 112 (e.g. eNB) of the primary MNO 110. The AR message issued by the UE device 103 specifies an IMSI within a range of IMSI values allocated to mobile devices associated with the private MVNO 120. The attach request is used to establish mobile wireless service connectivity for the UE device 103, via the primary MNO 110.

During 202, the RAN 122 forwards the attach request (via messaging) to the MME 116.

During 203 (from which a sequence of several communications and operations are omitted since the operations are well-established/known) the MME 116 receives and processes the attach request by initially issuing an update location request (ULR) and receiving an update location answer (ULA) in accordance with known ULR processing operations.

Thereafter, during 204 the MME 116 issues a create session request (CSR) message corresponding to the AR received during 202. The CSR message includes the IMSI and ULI of the UE device 103, to the SGW 113 to initiate creation of a new session supporting a connection of the UE device 103 to the Primary MNO 110.

During 205, the SGW 113 forwards the CSR including the IMSI and ULI associated with the UE device 103, to the GTP proxy 118 of the primary MNO 110.

During 206, in response to receiving the create session request from the SGW 113, the GTP proxy 118 issues an access request (including the IMSI and ULI of provided in the AR message during 201) to the access policy module extension (APMx) 119.

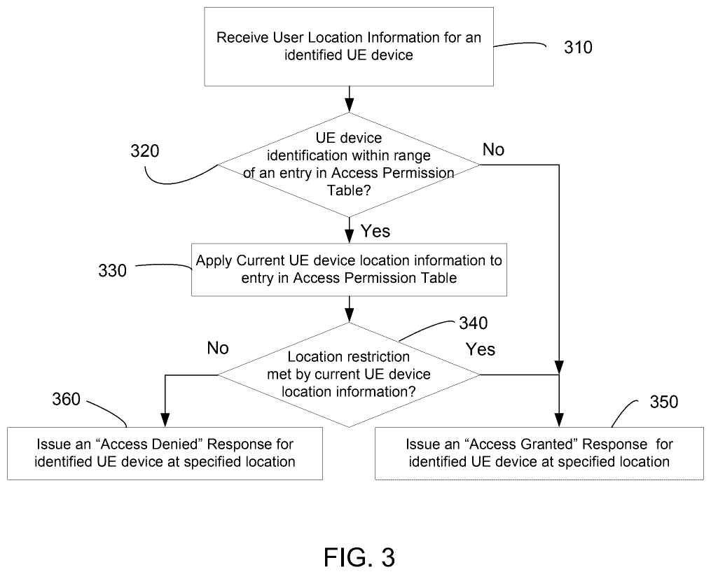

Thereafter, during 207 the APMx 119 processes the access request received from the GTP proxy 118. By way of example, and with reference to FIG. 3, during 310, the APMx 119 receives ULI for the UE device 103 that is identified by an IMSI value. During 320, the APMx determines whether the identified UE device 103 is within a range of IMSI values provided for an entry in the access permission table 117. If a corresponding entry indeed exists in the access permission table 117, then control passes to 330.

During 330, the APMx 119 applies the ULI information (previously provided by the UE device 103) to the entry in the access permission table 117 specifying a geographic area limitation for the provided identity (e.g., IMSI value) of the UE device 103. Thereafter, during 340 if the ULI information provided for the UE device 103 falls within the geographic area limitation specified by the entry in the access permission table 117, then control passes to 350 wherein the APMx 119 issues an access granted response to the GTP proxy during 208 (in FIG. 2).

However, during 340 if the ULI information provided for the UE device 103 indicates that the UE device 103 is seeking to connect to a RAN node from a current location that is outside the geographic area limitation specified by the entry in the access permission table 117, then control passes to 360 wherein the APMx 119 issues an access denied response to the GTP proxy (not shown in FIG. 2).

Moreover, returning to 320, if a corresponding entry does not exist in the access permission table 117, then no geographic limitation has been placed on the particular provided identity value, and in such case control passes to 350 described herein above.

The GTP proxy 118 is configured with a mapping of particular IMSI values (e.g. IMSI blocks/ranges) to corresponding PGWs. As such, during 210 the GTP proxy 118 of the primary MNO 110 obtains an identity of the PGW 128 that is associated with the IMSI provided with the initial attach request for the UE device 103 and forwards the CSR to the PGW 128 with which the UE device 103 is associated by virtue of the IMSI provided by the UE device 103 in the AR message provided to the RAN 112 during 201.

During 211, the private MVNO 120 sets up a session for the UE device 103, and during 212 issues a create session response to the GTP proxy 118 accepting/acknowledging the CSR forwarded during 210.

Returning to FIG. 2, during 219, in accordance with the APMx 119 previously confirming that the UE device 103 is attaching at a geographic location within a geographic area limit defined by an entry in the access permission table 117, the GTP proxy 118 modifies the create session response received during 212 by including a change reporting action information element (IE) indicating that location reporting is requested (e.g., a changed Tracking Area Identifier (TAI) and an e-Cell Global Identifier (ECGI)).

Thereafter, during 220 the GTP proxy 118 forwards the modified create session response (issued by the PGW 128 to the GTP proxy 118 during 212) to the SGW 113.

During 221, the SGW 113, in turn, forwards the create session response to the MME 116.

During 230, the MME 116 registers the ULI provided by the UE device 103 with the initial AR message received during 202. As a result of the GTP proxy 118 previously modifying (during 219) the create session response to indicate that location reporting is requested, the MME 116 will include any subsequent ULI included in subsequent modify bearer request messages arising from subsequent mobility events involving the UE device 103—subsequent to completing the response to the initial AR issued during 201.

During 232, the MME 116 sends an accept AR message to the RAN 112 node that previously forwarded the AR message from the UE device 103.

During 234, the RAN 112 of the primary MNO issues an accept AR to the UE device 103.

Though not shown in FIG. 2, if the APMx 119 determines during 207 that the UE device 103 issued an attach request while at a geographic location that is not within the limits specified by an entry in the access permission table 117, then the GTP proxy 118 rejects CSR received during 205. By way of example, the GTP proxy 118 issues a create session response including a “service not supported” (or similar failure code) message to the SGW 113 instead of a session grant message that was issued in response to access being granted (during 208 described herein above).

While the present example involve establishing a connection handled by the primary MNO 110, the present disclosure contemplates similar operation of the primary MNO 110 to handle an attach request (or mobility event/TAU) originating from the secondary MNO 100—without a need to modify any components of the secondary MNO 100 core.

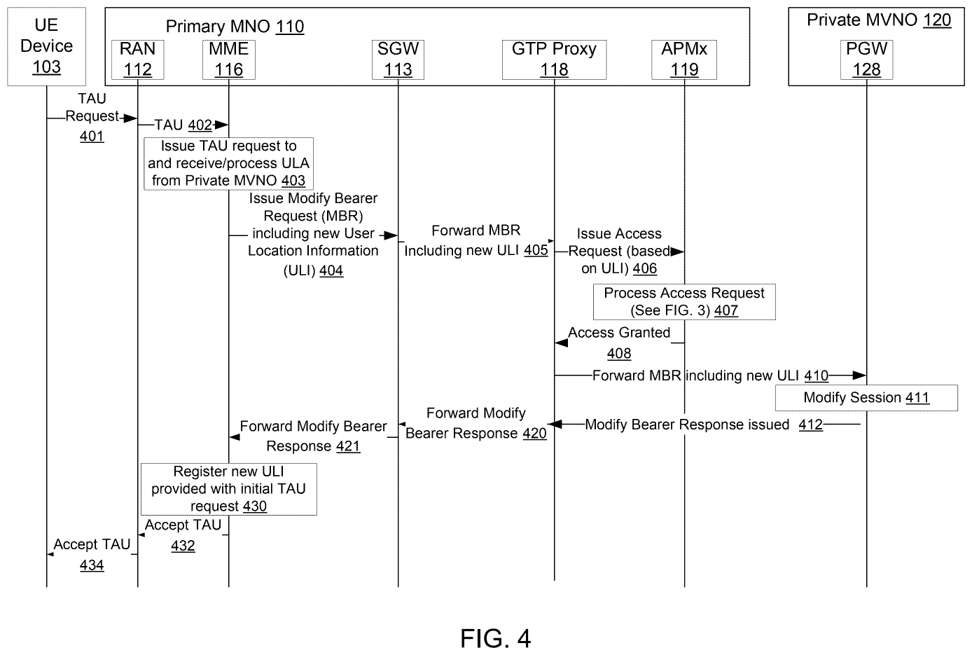

Having described an example case of an initial attach request case, attention is now directed to FIG. 4 that summarizes a sequence where the UE device 103 successfully transitions to another RAN node in accordance with a geographic location limitation enforced by the GTP proxy 118 and APMx 119 in accordance with an entry in the access permission table 117.

During 401 the UE device 103 issues a tracking area update (TAU) message (or other “mobility event” related message) including one or more pieces of known user location information (ULI) that is received by the RAN 112 (e.g. eNB) of the primary MNO 110. The TAU message issued by the UE device 103 specifies an IMSI within a range of IMSI values allocated to mobile devices associated with the private MVNO 120. The TAU message initiates operations associated with establishing a new RAN connection in association with a mobility event involving the UE device 103, via the primary MNO 110.

During 402, the RAN 122 forwards the TAU (via messaging) to the MME 116.

During 403 (from which a sequence of several communications and operations are omitted since the operations are well-established/known) the MME 116 receives and processes the TAU message.

In the illustrative example, the particular TAU did not necessitate changing MME or SGW components. However, such changes would not change the ultimate handling of the resulting MBR by the GTP proxy 118 and APMx 119 in the manner described herein—other than the potential need to create a new session (i.e., issue a CSR as opposed to issuing a modify bearer request (MBR) in accordance with the discussion herein below).

Thereafter, during 404 the MME 116 issues a modify bearer request (MBR) message corresponding to the TAU message received during 402. In view of the previous configuration of the MME 116 during 230 to report changes in ULI associated with the UE device 103, the MME 116 issues a modify bearer request (MBR) message that includes updated ULI (e.g. TAI and ECGI) to the SGW 113 to initiate establishing a new bearer supporting a connection of the UE device 103 to the Primary MNO 110 for the previously established session.

During 405, the SGW 113 forwards the MBR including the IMSI and ULI associated with the UE device 103, to the GTP proxy 118 of the primary MNO 110.

During 406, in response to receiving the MBR from the SGW 113, the GTP proxy 118 issues an access request (including the IMSI and ULI of provided in the MBR message during 405) to the access policy module extension (APMx) 119.

Thereafter, during 407 the APMx 119 processes the access request received from the GTP proxy 118 in accordance with the operations described herein above with reference to FIG. 3.

If the ULI information provided for the UE device 103 falls within the geographic area limitation specified by the entry in the access permission table 117, then the APMx 119 issues an access granted response to the GTP proxy during 408.

Thereafter, during 410 the GTP proxy 118 of the primary MNO 110 forwards the MBR (including potentially new ULI for the UE device 103) to the PGW 128 with which the UE device 103 is associated by virtue of the IMSI provided by the UE device 103 in the TAU message provided to the RAN 112 during 401.

During 411, the private MVNO 120 modifies the previously established session for the UE device 103 in accordance with the new ULI provided with the MBR.

During 412 the PGW 128 of the Private MVNO 120 issues a modify bearer response message to the GTP proxy 118 accepting/acknowledging the changed information provided in the MBR message from GTP proxy 118.

During 420, the GTP proxy 118 forwards the modify bearer response message (previously issued by the PGW 128 to the GTP proxy 118 during 412) to the SGW 113.

During 421, the SGW 113, in turn, forwards the modify bearer response message to the MME 116.

During 430, the MME 116 registers the updated ULI provided by the UE device 103 with the initial AR message received during 202. As a result of the GTP proxy 118 previously modifying (during 219 of FIG. 2) the create session response to indicate that location reporting is requested, the MME 116 will continue to include any subsequent ULI included in subsequent modify bearer request messages arising from subsequent mobility events involving the UE device 103.

During 432, the MME 116 sends an accept TAU message to the RAN 112 node that previously forwarded the TAU message from the UE device 103.

During 234, the RAN 112 of the primary MNO issues an accept TAU message to the UE device 103.

Though not shown in FIG. 4, if the APMx 119 determines during 407 that the UE device 103 issued a TAU message at a geographic location that is not within the limits specified by an entry in the access permission table 117, then the GTP proxy 118 rejects modify bearer request received during 405. By way of example, the GTP proxy 118 extracts a bearer identification (e.g. EPS Bearer ID—EBI) from the received modify bearer request message, and then issues a corresponding delete bearer request including the EBI to the SGW 113. The SGW 113, in turn, forwards the delete bearer request to the MME 116 to initiate detaching the UE 103 from the RAN 112.

Additionally, if the private MN sharing criteria is not met during 340, control also passes to the “access denied” alternative operation 360.

All references, including publications, patent applications, and patents, cited herein are hereby incorporated by reference to the same extent as if each reference was individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method, carried out by a mobile network (MN) core, for conditionally allowing a requested radio connection of an identified user equipment (UE) device associated with a mobile network operator associated with the MN core, wherein conditional access is based upon provided user equipment geographic location information indicating a current geographic location of the UE device seeking to establish the requested radio connection, the method comprising:
receiving, by an MN core component, an access request including the user equipment geographic location information indicating a current geographic location of the identified UE device;
determining, by the MN core component in accordance with receiving the access request, that the current geographic location of the identified UE device is within a pre-configured limited geographic area description within which the identified UE device is permitted radio access to the MN operator; and
generating, in accordance with the determining, an access granted message indicating permission for the UE device to connect to the MN operator through a radio access network (RAN).

2. The method of claim 1, further comprising:
propagating, in accordance with the generating, the access granted message to a mobility management entity (MME) component of MN operator.

3. The method of claim 2, wherein in accordance with the propagating, the MME component of the MN operation, in response to subsequently receiving a location change message associated with the identified UE device, generates a modify bearer request including a new user location information for the identified UE device corresponding to the location change message.

4. The method of claim 3, wherein the location change message is a tracking area update message.

5. The method of claim 1, wherein the access request is initiated by an attach request from the identified UE device.

6. The method of claim 1, wherein the determining comprises:
accessing an entry in an access permission table corresponding to an identifier of the identified UE device; and
confirming that the current location of the identified UE device falls within a geographic area defined by the pre-configured limited geographic area description corresponding to the entry.

7. The method of claim 1, wherein the MN core component is a GPRS Tunneling Protocol (GTP) proxy, and
wherein the determining is carried out by an extension of the GTP proxy referencing an access permission table comprising a set of entries, wherein each entry includes:
a UE device identifier value, and
a corresponding pre-configured limited geographic area description.

8. The method of claim 1, wherein the UE device identifier is an International Mobile Subscriber Identity (IMSI).

9. The method of claim 1, wherein the pre-configured limited geographic area descriptions comprise a tracking area code (TAC).

10. The method of claim 9, wherein the TAC includes a tracking area identifier and a cell identifier of a radio access network node.

11. A system comprising a mobile network (MN) core, wherein the MN core comprises:
at least one processor; and
a non-transitory computer-readable medium including computer-executable instructions that, when executed by the at least one processor, facilitate carrying out a method for conditionally allowing a requested radio connection of an identified user equipment (UE) device associated with a mobile network operator associated with the MN core, wherein conditional access is based upon provided user equipment geographic location information indicating a current geographic location of the UE device seeking to establish the requested radio connection, the method comprising:
receiving, by an MN core component, an access request including the user equipment geographic location information indicating a current geographic location of the identified UE device;
determining, by the MN core component in accordance with receiving the access request, that the current geographic location of the identified UE device is within a pre-configured limited geographic area description within which the identified UE device is permitted radio access to the MN operator; and
generating, in accordance with the determining, an access granted message indicating permission for the UE device to connect to the MN operator through a radio access network (RAN).

12. The system of claim 11, wherein the method further comprises:
propagating, in accordance with the generating, the access granted message to a mobility management entity (MME) component of MN operator.

13. The system of claim 12, wherein in accordance with the propagating, the MME component of the MN operation, in response to subsequently receiving a location change message associated with the identified UE device, generates a modify bearer request including a new user location information for the identified UE device corresponding to the location change message.

14. The system of claim 13, wherein the location change message is a tracking area update message.

15. The system of claim 11, wherein the access request is initiated by an attach request from the identified UE device.

16. The system of claim 11, wherein the determining comprises:
accessing an entry in an access permission table corresponding to an identifier of the identified UE device; and
confirming that the current location of the identified UE device falls within a geographic area defined by the pre-configured limited geographic area description corresponding to the entry.

17. The system of claim 11, wherein the MN core component is a GPRS Tunneling Protocol (GTP) proxy, and
wherein the determining is carried out by an extension of the GTP proxy referencing an access permission table comprising a set of entries, wherein each entry includes:
a UE device identifier value, and
a corresponding pre-configured limited geographic area description.

18. The system of claim 11, wherein the UE device identifier is an International Mobile Subscriber Identity (IMSI).

19. The system of claim 11, wherein the pre-configured limited geographic area descriptions comprise a tracking area code (TAC).

20. The system of claim 19, wherein the TAC includes a tracking area identifier and a cell identifier of a radio access network node.
